(19) United States
(12) Patent Application Publication
(10) Pub. No.: US 2026/0260894 A1
(43) Pub. Date: Sep. 3, 2026

(54) Cathode for Secondary Battery and Lithium Secondary Battery Including the Same

(71) Applicant: SK On Co., Ltd., Seoul (KR)

(72) Inventors: Ki Joo EOM, Daejeon (KR); Hyun Joong JANG, Daejeon (KR); Ji Won NA, Daejeon (KR); So Hyun PARK, Daejeon (KR)

(21) Appl. No.: 19/541,779

(22) Filed: Feb. 17, 2026

(30) Foreign Application Priority Data
Feb. 28, 2025 (KR) 10-2025-0026912

(51) Int. Cl. H01M 4/62; H01M 4/02; H01M 4/131; H01M 4/36; H01M 4/525

(52) U.S. Cl. CPC H01M 4/625; H01M 4/131; H01M 4/366; H01M 4/525; H01M 2004/021; H01M 2004/028

(57) ABSTRACT

A cathode for a secondary battery according to the present disclosure includes a cathode current collector, and a first cathode active material layer and a second cathode active material layer sequentially stacked on at least one surface of the cathode current collector. The first cathode active material layer includes a first conductive material including a particulate conductive material. The second cathode active material layer includes a second conductive material including a particulate conductive material and a fibrous conductive material. A ratio of a weight of the fibrous conductive material to a weight of the particulate conductive material in the second cathode active material layer is 0.2 to 2.5.

### CROSS-REFERENCE TO RELATED APPLICATION

This application claims priority to Korean Patent Applications No. 10-2025-0026912 filed on Feb. 28, 2025, the entire disclosure of which is incorporated by reference herein.

### BACKGROUND

### 1. Field

The present disclosure relates to a cathode for a secondary battery and a lithium secondary battery including the same.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as hybrid vehicles.

Examples of secondary batteries may include a lithium secondary battery, a nickel-cadmium battery, and a nickel-hydrogen battery. Among these, the lithium secondary battery has been actively developed and applied due to its high operating voltage, high energy density per unit weight, and advantages in charging speed and weight reduction.

For example, the lithium secondary battery may include: an electrode assembly including a cathode, an anode, and a separation membrane (separator); and an electrolyte that impregnates the electrode assembly. The lithium secondary battery may further include, for example, a pouch-type outer case that accommodates the electrode assembly and the electrolyte.

The lithium secondary battery preferably has high capacity and fast charge and discharge rates. Therefore, there is a need for the development of a cathode capable of realizing a high-capacity lithium secondary battery having improved fast charge and discharge performance.

### SUMMARY

According to an aspect of the present disclosure, there is provided a cathode for a secondary battery having improved electrochemical properties.

According to another aspect of the present disclosure, there is provided a lithium secondary battery including the cathode for a secondary battery.

A cathode for a secondary battery according to the present disclosure includes: a cathode current collector, and a first cathode active material layer and a second cathode active material layer sequentially stacked on at least one surface of the cathode current collector. The first cathode active material layer includes a first conductive material including a particulate conductive material. The second cathode active material layer includes a second conductive material including a particulate conductive material and a fibrous conductive material. A ratio of a weight of the fibrous conductive material to a weight of the particulate conductive material in the second cathode active material layer is 0.2 to 2.5.

According to exemplary embodiments, the ratio of the weight of the fibrous conductive material to the weight of the particulate conductive material in the second cathode active material layer may be 1 to 2.

According to exemplary embodiments, the content of the particulate conductive material based on the total weight of the second cathode active material layer may be 0.1% by weight to 2% by weight.

According to exemplary embodiments, the content of the fibrous conductive material based on the total weight of the second cathode active material layer may be 0.3% by weight to 2% by weight.

According to exemplary embodiments, the first conductive material may not include a fibrous conductive material.

According to exemplary embodiments, the fibrous conductive material may include multi-walled carbon nanotubes (MWCNTs).

According to exemplary embodiments, the content of the first conductive material may be 0.1% by weight to 3% by weight based on the total weight of the first cathode active material layer.

According to exemplary embodiments, the content of the first conductive material based on the total weight of the first cathode active material layer may be lower than the content of the second conductive material based on the total weight of the second cathode active material layer.

According to exemplary embodiments, the first cathode active material layer may include a first cathode active material, and the second cathode active material layer may include a second cathode active material, wherein the first cathode active material and the second cathode active material may each independently include a lithium metal oxide containing nickel, and wherein the molar content of nickel based on the total molar amount of metals excluding lithium and oxygen in the lithium metal oxide may be 30 mol % to 90 mol %.

According to exemplary embodiments, the molar content of nickel based on the total molar amount of metals excluding lithium and oxygen in the lithium metal oxide may be 60 mol % to 80 mol %.

According to exemplary embodiments, the first cathode active material layer and the second cathode active material layer may each independently have a thickness of 10 μm to 100 μm.

A lithium secondary battery according to the present disclosure includes: the cathode for a secondary battery; and an anode disposed opposite the cathode.

The cathode for a secondary battery according to exemplary embodiments of the present disclosure may include a cathode active material layer having high electrical conductivity. Accordingly, a battery having improved fast charge and discharge performance may be realized.

The lithium secondary battery according to exemplary embodiments of the present disclosure may have a low rate of increase in internal resistance even during repeated fast charge and discharge cycles, and may have improved battery cycle life characteristics during fast charge and discharge.

The cathode for a secondary battery and the lithium secondary battery including the same according to the present disclosure may be widely applied in green technology fields, such as electric vehicles, battery charging stations, as well as solar power generation, wind power generation, and the like, which use batteries. In addition, the cathode for a secondary battery and the lithium secondary battery including the same according to the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic cross-sectional view of a cathode for a lithium secondary battery according to an embodiment;

FIG. 2 is a plan view of a lithium secondary battery according to an embodiment; and

FIG. 3 is a schematic cross-sectional view of the lithium secondary battery according to an embodiment.

### DETAILED DESCRIPTION OF THE EMBODIMENTS

A cathode for a lithium secondary battery according to an exemplary embodiment of the present disclosure includes a cathode active material layer including a multilayer structure. In addition, a lithium secondary battery according to an exemplary embodiment of the present disclosure includes the cathode.

Hereinafter, exemplary embodiments of the present disclosure will be described in detail with reference to the accompanying drawings. However, these embodiments are merely illustrative, and the present disclosure is not limited to the specific embodiments described as examples.

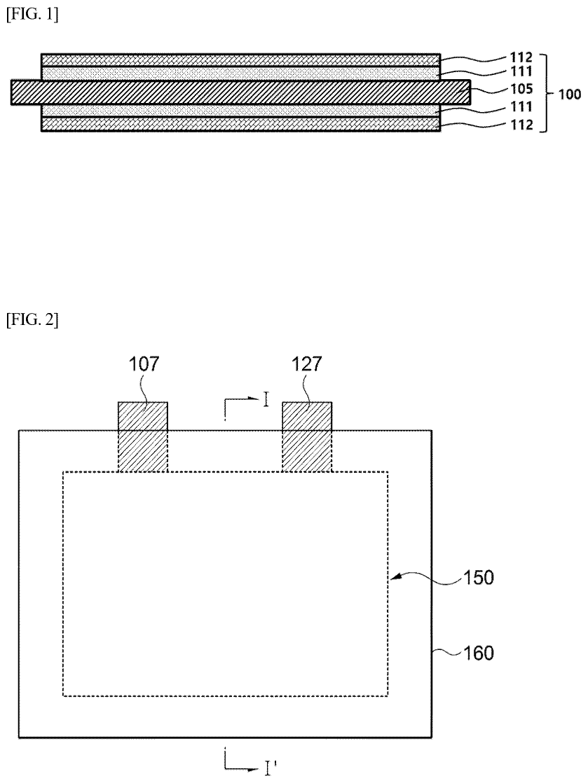

FIG. 1 is a schematic cross-sectional view of a cathode for a lithium secondary battery (hereinafter, also abbreviated as a “cathode”) according to an embodiment.

Referring to FIG. 1, a cathode 100 for a lithium secondary battery may include a cathode current collector 105 and a cathode active material layer disposed on at least one surface of the cathode current collector 105. The cathode active material layer may include a first cathode active material layer 111 and a second cathode active material layer 112, and the first cathode active material layer 111 and the second cathode active material layer 112 may be sequentially stacked on at least one surface of the cathode current collector 105.

According to exemplary embodiments, the first cathode active material layer 111 may be formed directly on the surface of the cathode current collector 105. The second cathode active material layer 112 may be formed directly on an upper surface of the first cathode active material layer 111 (e.g, a surface opposite a contact surface with the cathode current collector).

The cathode current collector 105 may include, for example, stainless steel, nickel, aluminum, titanium, copper, or an alloy thereof, and preferably, aluminum or an aluminum alloy.

The thickness of the cathode current collector 105 is not particularly limited, but may be 10 μm to 200 μm.

The first cathode active material layer 111 includes a first conductive material, and the first conductive material includes a particulate conductive material. The first conductive material may be used to improve the electrical conductivity of the first cathode active material layer 111.

The particulate conductive material may include carbon black, graphite, acetylene black, Ketjen black, or the like. For example, the particulate conductive material may include carbon black. In one embodiment, the first conductive material may be composed of carbon black.

According to exemplary embodiments, the content of the first conductive material may be 0.1% by weight (“wt %”) to 3 wt % based on the total weight of the first cathode active material layer 111. In some embodiments, the content of the first conductive material may be 0.5 wt % to 2.5 wt % based on the total weight of the first cathode active material layer 111. Within this range, the electrical conductivity of the first cathode active material layer 111 may be improved without degrading the fast charge and discharge performance of the battery.

According to exemplary embodiments, the first conductive material may not include a fibrous conductive material. For example, the first conductive material may be composed of a particulate conductive material, and the first cathode active material layer 111 may not include other conductive materials, such as Super P. Accordingly, a cathode having a high energy density may be realized.

The first cathode active material layer 111 may have a thickness of 10 μm to 100 μm. In some embodiments, the thickness of the first cathode active material layer 111 may be 30 μm to 80 μm.

The first cathode active material layer 111 may include a first cathode active material. The first cathode active material may include a lithium metal oxide containing nickel. The lithium metal oxide may further include at least one of cobalt (Co), manganese (Mn), and aluminum (Al) in addition to nickel.

According to exemplary embodiments, the lithium metal oxide may include nickel and manganese. Therefore, the battery may have a high capacity while exhibiting improved cycle life stability.

The molar content of nickel, based on the total molar amount of metals excluding lithium and oxygen in the lithium metal oxide, may be 30 mol % to 90 mol %. According to some embodiments, the molar content of nickel, based on the total molar amount of metals excluding lithium and oxygen in the lithium metal oxide, may be 60 mol % to 80 mol %.

Within the above range, an increase in internal resistance due to changes in the crystal structure of the cathode active material during fast charging and discharging of the battery may be reduced without significantly reducing the cathode capacity.

According to exemplary embodiments, the lithium metal oxide may include a layered structure represented by Formula 1 below.

LiₓNiₐM_{b}O_{2+z} [Formula 1]

In Formula 1, x, a, b and z may satisfy 0.9≤x≤1.2, 0.6≤a≤0.99, 0.01≤b≤0.4, and −0.5≤z≤0.1. As described above, M may include Co, Mn and/or Al.

The chemical structure represented by Formula 1 indicates a bonding relationship among elements included in the layered structure or the crystal structure of the cathode active material, and does not exclude the presence of additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form bonds, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may also act, for example, as an auxiliary active element that contributes to the capacity/output activity of the cathode active material together with Co or Mn, such as Al.

For example, the lithium metal oxide may include a layered structure or a crystal structure represented by Formula 1-1 below.

LiₓNiₐM1_{b1}M2_{b2}O_{2+z} [Formula 1-1]

In Formula 1-1, M1 may include Co, Mn and/or Al. M2 may include the above-described auxiliary elements. In Formula 1-1, x, a, b1, b2 and z may satisfy 0.9≤x≤1.2, 0.3≤a≤0.8, 0.01≤b1≤0.4, 0≤b2≤0.1, and −0.5≤z≤0.1.

The lithium metal oxide may further include a coating element or a doping element. For example, elements which are substantially the same as or similar to the above-described auxiliary elements may be used as the coating element or the doping element. For example, the above-described elements may be used alone or in combination oftwo or more thereof as the coating element or the doping element.

The coating element or the doping element may be present on the surface of the lithium metal oxide particles, or may penetrate through the surface of the lithium metal oxide particles to be incorporated into the bonding structure represented by Formula 1 or Formula 1-1 above.

In some embodiments, the first cathode active material may include a lithium cobalt oxide-based active material, a lithium manganese oxide-based active material, a lithium nickel oxide based active material, or a lithium iron phosphate (LFP)-based active material (e.g., LiFePO₄).

In some embodiments, the first cathode active material may include, for example, a manganese (Mn)-rich active material, a lithium (Li)-rich layered oxide (LLO)/over-lithiated oxide (OLO)-based active material, or a cobalt (Co)-less active material, which has a chemical structure or a crystal structure represented by Formula 2 below.

P[Li₂MnO₃]·(1-p[Li_{q}JO₂] [Formula 2]

In Formula 2, p and q may satisfy 0<p<1, 0.9≤q≤1.2, and J may include at least one element selected from Mn, Ni, Co, Fe, Cr, V, Cu, Zn, Ti, Al, Mg and B.

The second cathode active material layer 112 includes a second conductive material. The second conductive material includes a particulate conductive material and a fibrous conductive material. The second cathode active material layer 112 is an upper layer with respect to the cathode current collector 105 exposed to an electrolyte, and includes heterogeneous conductive materials, such that electron transfer to lithium ions at the surface of the second cathode active material layer 112 may be facilitated. Accordingly, the fast charge and discharge performance of the battery may be improved.

The content of the second conductive material may be 0.5 wt % to 3 wt %. In some embodiments, the content of the second conductive material may be 0.7 wt % to 2 wt %. Within this range, the fast charge and discharge performance of the battery may be further improved.

A ratio of a weight of the fibrous conductive material to a weight of the particulate conductive material in the second cathode active material layer 112 is 0.2 to 2.5. In some embodiments, the ratio of the weight of the fibrous conductive material to the weight of the particulate conductive material in the second cathode active material layer 112 may be greater than 1 and less than or equal to 2.5, 1 to 2.5, 1 to 2, or 1.2 to 1.7. In some embodiments, the ratio of the weight of the fibrous conductive material to the weight of the particulate conductive material in the second cathode active material layer 112 may be 0.2 to 1, 0.2 to 0.8, 0.2 to 0.7, or 0.2 to 0.6.

Within the above range, the internal resistance of the battery may not excessively increase during repeated fast charge and discharge cycles of the battery.

If the ratio of the weight of the fibrous conductive material to the weight of the particulate conductive material in the second cathode active material layer 112 is less than 0.2 or greater than 2.5, the content of the particulate conductive material or the fibrous conductive material may be excessive, such that the internal resistance of the battery may rapidly increase during fast charge and discharge cycles, and the cycle life characteristics of the battery may be degraded.

According to exemplary embodiments, the content of the particulate conductive material based on the total weight of the second cathode active material layer 112 may be 0.1 wt % to 2 wt %. In some embodiments, the content of the particulate conductive material based on the total weight of the second cathode active material layer 112 may be 0.2 wt % to 0.5 wt %, 0.2 wt % to 2 wt %, 0.5 wt % to 2 wt %, or 1 wt % to 2 wt %.

According to exemplary embodiments, the content of the fibrous conductive material based on the total weight of the second cathode active material layer 112 may be 0.3 wt % to 2 wt %. In some embodiments, the content of the fibrous conductive material based on the total weight of the second cathode active material layer 112 may be 0.5 wt % to 1 wt % or 0.3 wt % to 0.6 wt %.

Within this range, the fast charge and discharge performance of the battery may be further improved.

According to exemplary embodiments, the fibrous conductive material may include carbon nanotubes, vapor-grown carbon fibers (VGCF), carbon fibers, or the like. For example, the fibrous conductive material may include carbon nanotubes.

According to exemplary embodiments, the fibrous conductive material may include multi-walled carbon nanotubes (MWCNTs).

According to exemplary embodiments, the content of the first conductive material based on the total weight of the first cathode active material layer 111 may be lower than the content of the second conductive material based on the total weight of the second cathode active material layer 112. Accordingly, the second cathode active material layer 112 may include more pores, such that lithium ions may migrate more rapidly through the pores thereof. As a result, the fast charge and discharge performance of the battery may be further improved.

According to exemplary embodiments, the second cathode active material layer 112 may include a second cathode active material. The second cathode active material may include a lithium metal oxide containing nickel. The lithium metal oxide may be the same as that described for the first cathode active material.

The first cathode active material and the second cathode active material may be the same as or different from each other. For example, both the first cathode active material and the second cathode active material may be lithium metal oxides, and may have the same or different nickel contents.

For example, the type, metal composition, average particle size and particle size distribution, and particle crystal structure of the first cathode active material and the second cathode active material may be the same as or different from each other.

According to exemplary embodiments, the second cathode active material layer 112 may have a thickness of 10 μm to 100 μm. According to some embodiments, the thickness of the second cathode active material layer 112 may be 30 μm to 80 μm.

According to exemplary embodiments, the first cathode active material layer and the second cathode active material layer may each be formed by applying a slurry including the first conductive material or the second conductive material onto the surface of the cathode current collector or onto the first cathode active material layer, followed by drying and compressing.

For example, the first conductive material and the first cathode active material may be mixed and stirred with a binder and/or a dispersant in a solvent to prepare a first cathode slurry.

The first cathode slurry may be coated onto the cathode current collector 105, followed by drying and roll-pressing to form the first cathode active material layer 111.

A second cathode slurry, prepared by mixing and stirring the second conductive material and the second cathode active material with a binder and/or a dispersant in a solvent, may be applied onto the first cathode active material layer 111, followed by drying and roll-pressing. Accordingly, the second cathode active material layer 112 may be formed, and a cathode may be fabricated.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, aPVDF-based binder may be used as the cathode binder. In this case, the amount of the binder for forming the cathode active material layer may be reduced and the amount of the cathode active material may be relatively increased, thereby improving the output and capacity of the secondary battery.

A lithium secondary battery according to exemplary embodiments includes the above-described cathode described an anode disposed opposite the cathode. The lithium secondary battery may include a separator interposed between the cathode and the anode, and an electrolyte.

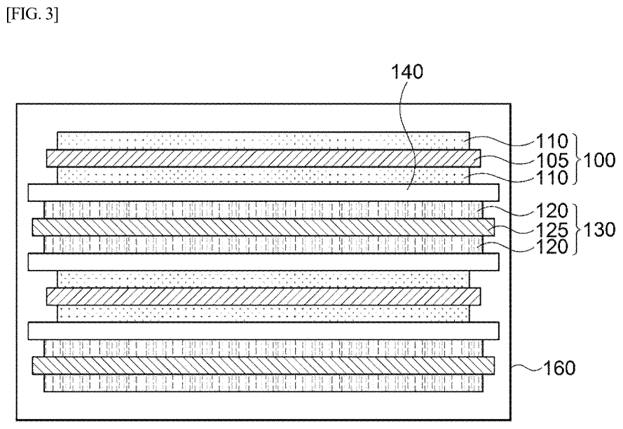

Hereinafter, the lithium secondary battery according to exemplary embodiments will be described in more detail with reference to the drawings. FIGS. 2 and 3 are a schematic plan view and a schematic cross-sectional view illustrating the lithium secondary battery according to exemplary embodiments, respectively. For example, FIG. 3 is a cross-sectional view taken along line I-I′ of FIG. 2.

Referring to FIGS. 2 and 3, the lithium secondary battery may include an electrode assembly including the cathode 100, the anode 130, and a separator 140 interposed between the cathode and the anode. The electrode assembly may be accommodated in a case 160 together with an electrolyte and may be impregnated with the electrolyte.

The cathode 100 includes the cathode current collector 105 and the cathode active material layer 110, wherein the cathode active material layer 110 includes a first cathode active material layer and a second cathode active material layer (not shown). The cathode 100 may be the same as described above.

The anode 130 may include an anode current collector 125, and an anode active material layer 120 formed by coating the anode current collector 125 with an anode active material. If necessary, the anode may include an anode binder and a conductive material.

As the anode active material, any active material known in the art may be used, so long as it is capable of absorbing and releasing lithium ions, without particular limitation. For example, carbon based materials such as crystalline carbon, amorphous carbon, carbon composites, carbon fibers, etc.; a lithium alloy; a silicon (Si) compound or tin, and the like may be used. Examples of the amorphous carbon may include hard carbon, coke, mesocarbon microbead (MCMB), mesophase pitch-based carbon fiber (MPCF) or the like.

Examples of the crystalline carbon may include graphite-based carbon such as natural graphite, artificial graphite, graphitized coke, graphitized MCMB, graphitized MPCF or the like. Other elements contained in the lithium alloy may include, for example, aluminum, zinc, bismuth, cadmium, antimony, silicon, lead, tin, gallium or indium, etc.

The silicon compound may include, for example, silicon, silicon oxide or a silicon-carbon composite compound such as silicon carbide (SiC).

In some embodiments, the content of the silicon active material based on the total weight of the anode active material may be 1 to 20 wt %, 1 to 15 wt %, or 1 to 10 wt %.

The anode active material may be mixed and stirred with a binder, conductive material, and/or dispersant in a solvent to prepare a slurry. The slurry may be coated onto the anode current collector 125, followed by drying and compressing to prepare the anode active material layer 120.

For example, an anode slurry may be prepared by mixing the anode active material with the above-described components in a solvent. The anode slurry may be applied or deposited on the anode current collector, and then dried and roll-pressed to prepare the anode active material layer 120. The coating process may be performed using methods such as gravure coating slot die coating simultaneous multilayer die coating imprinting doctor blade coating dip coating bar coating or casting etc., but is not limited thereto. The anode active material layer 120 may further include a binder and optionally may further include a conductive material, a thickener, etc.

Non-limiting examples of the solvent may include water, purified water, deionized water, distilled water, ethanol, isopropanol, methanol, acetone, n-propanol, t butanol, etc.

The above-described materials that can be used when preparing the cathode as the binder, conductive material and thickener may also be used for the anode.

In some embodiments, a styrene-butadiene rubber (SBR)-based binder, carboxymethyl cellulose (CMC), polyacrylic acid based binder, poly(3,4-ethylenedioxythiophene) (PEDOT)-based binder, and the like may be used as an anode binder.

The separator 140 may be interposed between the cathode 100 and the anode 130. The separator 140 may include a porous polymer film made of a polyolefin polymer such as ethylene homopolymer, propylene homopolymer, ethylene/butene copolymer, ethylene/hexene copolymer, or ethylene/methacrylate copolymer. The separator 140 may include a nonwoven fabric made of glass fibers having a high melting point, polyethylene terephthalate fibers, etc.

In some embodiments, the anode 130 may have an area (e.g., a contact area with the separator 140) and/or volume greater than that of the cathode 100. Thereby, lithium ions generated from the cathode 100 may smoothly migrate to the anode 130 without being precipitated during the process, for example.

According to exemplary embodiments, an electrode cell is defined by the cathode 100, the anode 130 and the separator 140, and a plurality of electrode cells may be stacked to form, for example, a jelly roll type electrode assembly 150. For example, the electrode assembly 150 may be formed by winding stacking or folding the separator 140.

The electrode assembly 150 may be accommodated in the case 160 together with the non-aqueous electrolyte according to the above-described exemplary embodiments to define the lithium secondary battery. According to exemplary embodiments, the non-aqueous electrolyte may be used as the electrolyte.

The non-aqueous electrolyte may include a lithium salt of an electrolyte and an organic solvent. The lithium salt is represented by, for example, Li⁺X⁻, and as an anion (X⁻) of the lithium salt F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆F⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, and the like may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfuroxide, acetonitrile, dimethoxyethane, diethoxyethane, vinylene carbonate, sulfolane, γ-butyrolactone, propylene sulfite and tetrahydrofuran, and the like may be used. These may be used alone or in combination of two or more thereof.

As shown in FIG. 2, electrode tabs (cathode tabs and anode tabs) protrude from the cathode current collector 105 and the anode current collector 125, respectively, which belong to respective electrode cells, and may extend to one side of the case 160. The electrode tabs may be welded together with the one side of the case 160 to form electrode leads (a cathode lead 107 and an anode lead 127) that extend or are exposed to an outside of the case 160.

The lithium secondary battery may be manufactured, for example, in a cylindrical, prismatic, pouch, or coin type using a can.

Hereinafter, the embodiments of the present disclosure will be further described with reference to specific experimental examples. The examples and comparative examples included in the experimental examples are merely illustrative of the present disclosure and do not limit the scope of the appended claims. It will be apparent to those skilled in the art that various changes and modifications to the examples can be made within the scope and technical spirit of the present disclosure, and it is also understood that such changes and modifications fall within the scope of the appended claims.

### Example 1

### Fabrication of Cathode

A first cathode slurry was prepared by mixing LiNi_{0.7}Mn_{0.23}O₂ as a first cathode active material, PVDF as a binder, and carbon black as a first conductive material in a weight ratio of 96:3:1.

A second cathode slurry was prepared by mixing LiNi_{0.7}Mn_{0.23}O₂ as a second cathode active material, PVDF as a binder, and carbon nanotubes (CNTs) and carbon black (CB) as second conductive materials in a weight ratio of 96:3:0.6:0.4.

The first cathode slurry was uniformly applied onto an aluminum foil (12 μm in thickness), and the second cathode slurry was uniformly applied onto the first cathode slurry, followed by drying and roll-pressing to form a first cathode active material layer having an areal density of 12 mg/cm² and a thickness of 35 μm, and a second cathode active material layer having an areal density of 12 mg/cm² and a thickness of 35 μm, thereby fabricating a cathode.

### Manufacture of Lithium Secondary Battery

An anode active material slurry was prepared by mixing artificial graphite and natural graphite as anode active materials, styrene-butadiene rubber as a binder, and carboxymethyl cellulose as a thickener in a weight ratio of 98:1:1, and then dispersing the mixture in water. The slurry was coated onto a copper foil having a thickness of 6 μm, followed by drying and roll-pressing to fabricate an anode.

A film separator made of polyethylene (PE) material having a thickness of 13 μm was stacked between the fabricated electrodes, and a cell was assembled using a pouch having dimensions of 13.3 mm (thickness)×301 mm (width)×110 mm (length). A non-aqueous electrolyte was then injected into the pouch to manufacture a 70 Ah-class lithium secondary battery (energy density E805) for an electric vehicle (EV). As the non-aqueous electrolyte, a solution in which LiPF₆ was dissolved at a concentration of 1 M in a mixed solvent containing ethylene carbonate and ethyl methyl carbonate in a volume ratio of 25:75 was used.

### Example 2

A cathode and a battery were manufactured in the same manner as in Example 1, except that the second cathode slurry was prepared by mixing a second cathode active material, a binder, carbon nanotubes, and carbon black in a weight ratio of 97.4:1:0.6:1.

### Example 3

A cathode and a battery were manufactured in the same manner as in Example 1, except that the second cathode slurry was prepared by mixing a second cathode active material, a binder, carbon nanotubes, and carbon black in a weight ratio of 97.2:1:0.3:1.5.

### Example 4

A cathode and a battery were manufactured in the same manner as in Example 1, except that the second cathode slurry was prepared by mixing a second cathode active material, a binder, carbon nanotubes, and carbon black in a weight ratio of 97.5:1:0.3:1.2.

### Comparative Example 1

A cathode and a battery were manufactured in the same manner as in Example 1, except that the second cathode slurry was prepared by mixing a second cathode active material, a binder, carbon nanotubes, and carbon black in a weight ratio of 97.3:1:0.2:1.5.

### Comparative Example 2

A cathode and a battery were manufactured in the same manner as in Example 1, except that the second cathode slurry was prepared by mixing a second cathode active material, a binder, carbon nanotubes, and carbon black in a weight ratio of 97.4:1:1.2:0.4.

### Comparative Example 3

A cathode and a battery were manufactured in the same manner as in Example 1, except that the second cathode slurry was prepared by mixing a second cathode active material, a binder, and carbon black in a weight ratio of 96.5:1:2.5.

### Comparative Example 4

A cathode and a battery were manufactured in the same manner as in Example 1, except that the second cathode slurry was applied onto the cathode current collector, the first cathode slurry was applied onto the second cathode slurry, and then dried and roll-pressed to form a first cathode active material layer and a second cathode active material layer.

### Experimental Example: Evaluation of Fast Charge and Discharge Performance

The batteries of the examples and comparative examples were charged to 80% SOC, stored for 10 minutes, and then discharged to 10% SOC, and the initial discharge capacity (R1) was measured.

In addition, for the batteries of the examples and comparative examples, charging to 80% SOC for 20 minutes and discharging to 10% SOC at 0.5C CC were defined as one cycle, and the cycle was repeated 400 times. After the repeated cycles, the discharge capacity value (R2) was measured when the batteries were charged to 80% SOC, stored for 10 minutes, and then discharged to 10% SOC.

The cycle life retention was calculated from a value (R2/R1) obtained by dividing the discharge capacity value at the 400th cycle by the initial discharge capacity value.

The evaluation results are shown in Table 1 below.

TABLE 1

| | | | | | | | Cycle life retention |
|---|---|---|---|---|---|---|---|
| | | | | Conductive | | | under fast charge and |
| Second cathode | | Active | Binder | material | | CNT/CB | discharge @ 400 |
| slurry composition | | material | PVDF | CNT | CB | ratio | cycles |
| Example | 1 | 98 | 1 | 0.6 | 0.4 | 1.50 | 92.5% |
| | 2 | 97.4 | 1 | 0.6 | 1 | 0.60 | 94.0% |
| | 3 | 97.2 | 1 | 0.3 | 1.5 | 0.20 | 94.7% |
| | 4 | 97.5 | 1 | 0.3 | 1.2 | 0.25 | 93.4% |
| Comparative | 1 | 97.3 | 1 | 0.2 | 1.5 | 0.13 | 84.7% |
| Example | 2 | 97.4 | 1 | 1.2 | 0.4 | 3.00 | 88.5% |
| | 3 | 96.5 | 1 | 0 | 2.5 | 0.00 | 79.8% |

Referring to Table 1, in the batteries of the examples, which included cathodes containing a fibrous conductive material and a particulate conductive material in an upper layer at predetermined content ratios, the internal resistance of the battery did not increase significantly even during repeated fast charge and discharge cycles, thereby resulting in improved battery cycle life properties.

Conversely, in the batteries of the comparative examples, which contained relatively high contents of a fibrous conductive material or a particulate conductive material in the upper cathode layer, the internal resistance of the battery changed much more rapidly than in the batteries of the examples, thereby exhibiting deteriorated battery cycle life properties. In addition, Comparative Example 4 showed a cycle life retention of 73.7%, thereby demonstrating deteriorated cycle life properties relative to the Examples.

The contents described above are merely examples of applying the principles of the present disclosure, and other configurations may be further included without departing from the scope of the present disclosure.

What is claimed is:

1. A cathode for a secondary battery comprising:
a cathode current collector, and
a first cathode active material layer and a second cathode active material layer sequentially stacked on at least one surface of the cathode current collector,
wherein the first cathode active material layer comprises a first conductive material including a particulate conductive material,
wherein the second cathode active material layer comprises a second conductive material including a particulate conductive material and a fibrous conductive material, and
wherein a ratio of a weight of the fibrous conductive material to a weight of the particulate conductive material in the second cathode active material layer is 0.2 to 2.5.

2. The cathode for a secondary battery according to claim 1, wherein the ratio of the weight of the fibrous conductive material to the weight of the particulate conductive material in the second cathode active material layer is 1 to 2.

3. The cathode for a secondary battery according to claim 1, wherein the content of the particulate conductive material based on the total weight of the second cathode active material layer is 0.1% by weight to 2% by weight.

4. The cathode for a secondary battery according to claim 1, wherein the content of the fibrous conductive material based on the total weight of the second cathode active material layer is 0.3% by weight to 2% by weight.

5. The cathode for a secondary battery according to claim 1, wherein the first conductive material does not include a fibrous conductive material.

6. The cathode for a secondary battery according to claim 1, wherein the fibrous conductive material includes multi-walled carbon nanotubes (MWCNTs).

7. The cathode for a secondary battery according to claim 1, wherein the content of the first conductive material is 0.1% by weight to 3% by weight based on the total weight of the first cathode active material layer.

8. The cathode for a secondary battery according to claim 1, wherein the content of the first conductive material based on the total weight of the first cathode active material layer is lower than the content of the second conductive material based on the total weight of the second cathode active material layer.

9. The cathode for a secondary battery according to claim 1, wherein the first cathode active material layer comprises a first cathode active material, and the second cathode active material layer comprises a second cathode active material,
wherein the first cathode active material and the second cathode active material each independently include a lithium metal oxide containing nickel, and
wherein the molar content of nickel based on the total molar amount of metals excluding lithium and oxygen in the lithium metal oxide is 30 mol % to 90 mol %.

10. The cathode for a secondary battery according to claim 9, wherein the molar content of nickel based on the total molar amount of metals excluding lithium and oxygen in the lithium metal oxide is 60 mol % to 80 mol %.

11. The cathode for a secondary battery according to claim 1, wherein the first cathode active material layer and the second cathode active material layer each independently have a thickness of 10 μm to 100 μm.

12. A lithium secondary battery comprising:
the cathode for a secondary battery according to claim 1; and
an anode disposed opposite the cathode.
